(19) United States
(12) Patent Application Publication
(10) Pub. No.: US 2011/0068999 A1
(43) Pub. Date: Mar. 24, 2011

(54) SHAPED ACTIVE MATRIX DISPLAYS

(75) Inventor: ROBERT A. STREET, PALO ALTO, CA (US)

(73) Assignee: PALO ALTO RESEARCH CENTER INCORPORATED, Palo Alto, CA (US)

(21) Appl. No.: 12/563,945

(22) Filed: Sep. 21, 2009

(51) Int. Cl. G09G 3/20; H01J 9/00

(52) U.S. Cl. 345/55; 445/24

(57) ABSTRACT

A display system has an array of display elements on a substrate arranged into a shape having a non-rectangular perimeter, and address lines arranged to transmit signals to the display elements, the address lines conforming at least partially to the non-rectangular perimeter. A display system has an array of display elements arranged on a substrate, the substrate having at least one holes, and address lines arranged on the substrate to address the display elements, the address lines being routed according to the hole. A method of manufacturing a display system includes providing a substrate having a curved perimeter, mapping a rectangular addressing matrix to a curved matrix, the curved matrix based on the curved perimeter, forming address lines according to the curved matrix such that the address lines converge on at least one point, providing an array of display elements arranged to be addressable by the address lines, and providing control circuitry at the point to provide signals to the display elements through the address lines. A method of manufacturing a display system includes providing a substrate, arranging address lines on the substrate, such that the address lines are routed to avoid at least one region on the substrate, forming a hole in the region, wherein the hole penetrates at least partially into the substrate, and providing display elements on the substrate, arranged to be addressable by the address lines.

### BACKGROUND

Displays generally have a flat and rectangular shape. One reason lies in the nature of active matrix addressing. Address lines generally take a row-column format, lending themselves to x-y grid types of layouts. Another reason for flat, rectangular shaped displays results from the glass substrates used in conventional manufacturing. The glass has high cost and does not easily cut into non-rectangular shapes without damaging or wasting the glass. When the display functions as a computer monitor or television, the image content received for display generally arrives formatted for a rectangular display as well.

Moving away from rectangular displays may have several advantages. Many current signs have shapes designed to attract customers. Adding a display feature to these signs may help attract more customers, but the displays need to fit into the overall shape of the sign, as well as maintain a similar look to the existing signs for that company. Some of these signs consist of letters naming a product or store. Making displays that conform to the lettering shape maintains the brand style but adds extra interest to the sign.

Another area encompasses the displays embedded into products to provide controls or other features. Consumer and business product designs increasingly include curved shapes to raise their appeal to consumers. Displays should conform to these shapes, such as in a car dashboard. Toys and games would ideally have displays that conform to the overall shape of the item, rather than requiring the item to accommodate the display.

In addition, some displays used in control systems need to have control knobs or switches nearby. The design space would increase if these controls could reside in the display, rather than around the perimeter. Examples include a car radio or heater in a dashboard with a display, where the control knobs resided within the display.

The use of flexible substrates can enable non-rectangular shapes and conform to curved surfaces. Laser machining and other techniques allow cutting of the flexible substrates into complex shapes or discontinuous shapes with holes or gaps. The design of addressing lines for the individual picture elements (pixels) of the display remains problematic.

### BRIEF DESCRIPTION OF THE DRAWINGS

FIG. 1 shows examples of curved, non-rectangular, and curved and non-rectangular display shapes.

FIG. 2 shows an oval display having rectangular addressing.

FIG. 3 shows an embodiment of mapping rectangular addressing to a curved surface.

FIG. 4 shows an embodiment of addressing lines for a polygon shape.

FIG. 5 shows an embodiment of display having controls.

FIG. 6 shows an embodiment of a display having controls as part of the display.

FIG. 7 shows an embodiment of address lines routed to accommodate a discontinuity.

FIG. 8 shows an embodiment of a display having holes and gaps where the address lines are routed to accommodate the holes.

### DETAILED DESCRIPTION OF THE EMBODIMENTS

Developments in display technologies will lead to less expensive displays. These displays will become more prevalent, embedded in products, signs and advertisements. Applications in signs, brand names and for integration into products with curved shapes will require differently shaped displays. The ability to fabricate displays on flexible substrates allows possibilities for non-traditionally shaped displays.

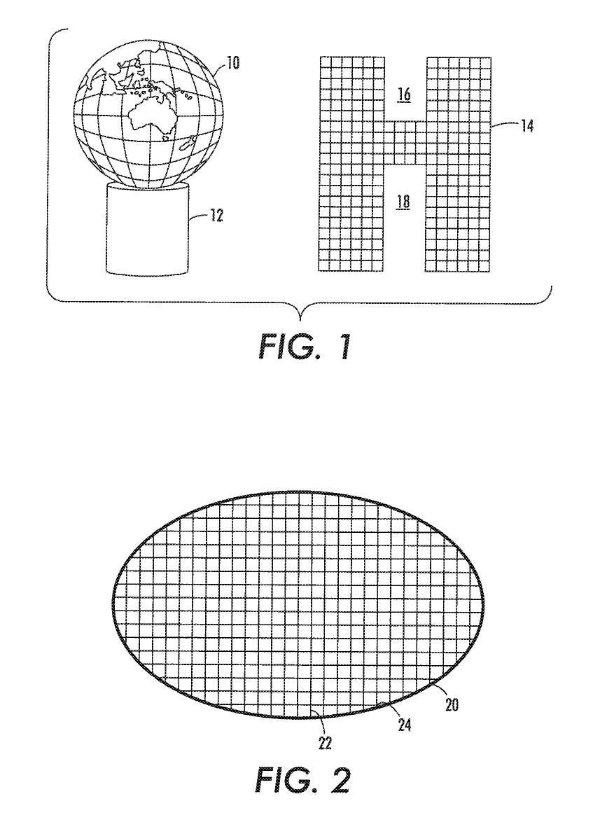

FIG. 1 shows examples of these types of displays, including a spherical display 10 on pedestal or stand 12, and a display embedded in a letter shape, in this case the letter ‘H’, as might be seen as part of a sign on a business or other entity. The letter shaped display 14 shows the address and column lines that might exist inside the shape, resulting in discontinuities in the lines at gaps 16 and 18.

One limitation in developing curved or non-rectangular displays lies in the nature of addressing matrixes used in addressing pixilated displays in which the display elements reside in a rectangular, x-y grid. As can be seen in the examples of FIG. 1, a rectangular grid of address lines would cause problems on either a curved surface or on a surface in which the address lines are for a non-rectangular shape.

It is possible to use rectangular addressing in non-rectangular shapes, as seen in FIG. 2. The display 20 has an oval shape, and the address lines such as 22 and 24 are set out in their typical grid fashion. However, some weaknesses exist in this design. For example, the addressing lines in each direction cover half of the oval or ellipse and would be difficult to connect to the readout electronics and the row and column drivers. The boundary of the display occurs at an arbitrary point on the pixel matrix, making it difficult to adapt the display image to fit into the display.

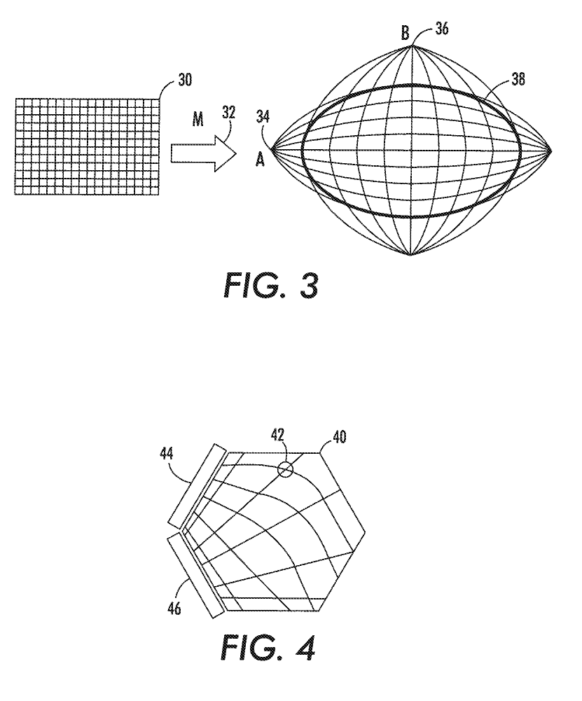

FIG. 3 shows an alternative approach to imposing a rectangular grid of addressing lines onto a non-rectangular shape. This approach maps a rectangular addressing matrix 30 to a non-rectangular, in this case curved, matrix based upon display shape 38 by applying a mapping process 32. The mapping process allows the display image to easily transform from its rectangular form to another suitable appearance. Alternatively, if the image form is unchanged, the curved addressing will cause the image on the oval shape appear as if it is on a three-dimensional dome shape, providing the illusion of depth.

Using the circular or curved address lines provides at least one point such as 34 or 36 at which the address lines converge, although convergence at a point is not essential. The curved shape of the address lines facilitates the positioning of the readout and driver electronics. The location of the convergence point or points can increase or decrease the curvature of the addressing matrix. In the example given, the center of the curved matrix approximates a rectangular array at the center of the display 38. The address lines near the perimeter follow the curvature of the display shape 38. Generally, the address lines will follow the curved perimeter at least for a long a portion of their length.

In addition to mapping to curved perimeters, the mapping allows for less symmetrical curved shapes, or to polygon shapes such as pentagons, hexagons, etc. FIG. 4 shows an example of a mapping for a hexagonal display.

In FIG. 4, the display 40 has a hexagonal shape with the address lines for the rows and columns arranged on adjacent sides of the hexagon. This allows convenient placement of the drive and readout electronics 44 and 46. In addition, the row and column lines become almost orthogonal where they cross such as at point 42 as they would in a traditional, rectangular matrix.

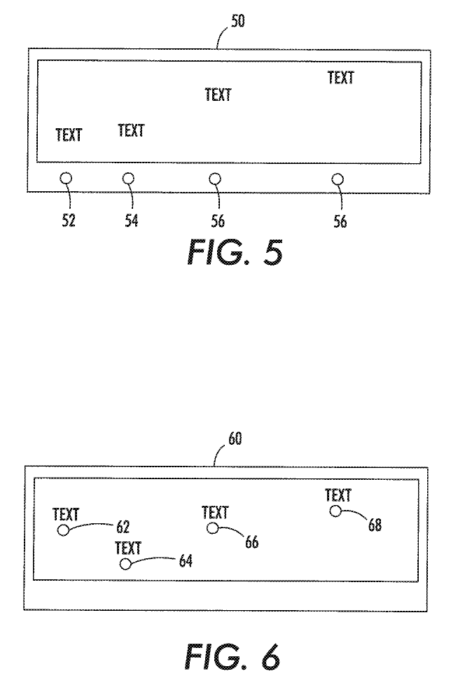

The ability to map address lines to non-rectangular shapes on flexible substrates also allows the presence of discontinuities, such as gaps and holes, in the substrate. This has several advantages. Looking at FIG. 5, one can see a display having text that may or may not be associated with the different control devices 52, 54, 56, and 58. Many types of electronics have control devices that perform different functions depending upon the activation or manipulation of other controls.

For example, control device 52 may be an on/off switch, and controls 54, 56 and 58 may perform one set of functions. When the control 52 is activated, turned ‘on,’ the functions associated with controls 54, 56 and 58 may change, which is why the label for each control is set out on a changeable display rather than a printed or otherwise fixed label. It would be more pleasing and may provide for more flexibility if the controls could be mounted within the display panel.

FIG. 6 shows an embodiment of a display 60 in which control devices 62, 64, 66 and 68 are embedded within the display. While not shown here, this may allow for smaller displays on the apparatus, or may provide many other features due to the flexible nature of the controls.

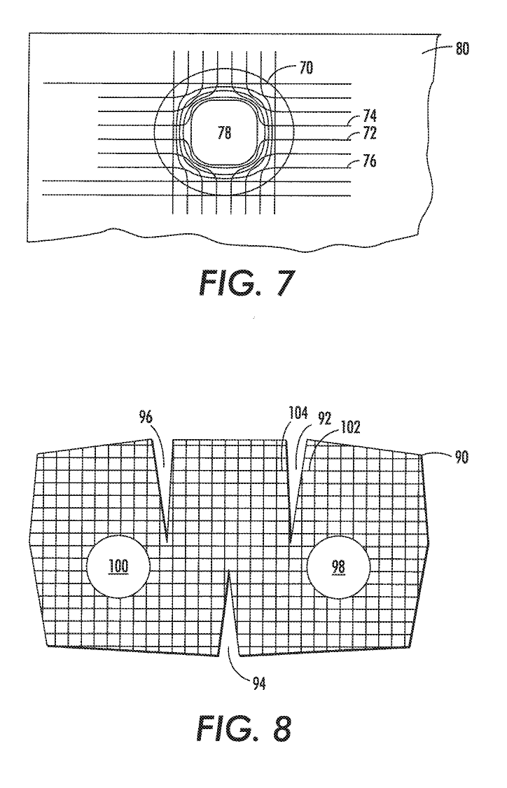

In order to provide the holes for the control devices as shown in FIG. 6, one must route the lines that would otherwise reside in the region of the hole to a different location. An example of such re-routing is shown in FIG. 7. The desire is to place a hole either through the substrate or at least partially through the substrate 80 upon which the display elements will reside. The region 70 has been identified as the region where it is desirable to form a hole.

The address lines such as 72, 74 and 76 are then routed to avoid that region. As can be seen the line 76, closer to the outside perimeter of the region, has only a slight bend in it, while the lines 72 and 74 have larger bends, being closer to the center of the region. In addition, the center lines 72 and 74 may route in opposite directions around the hole.

Once the lines have been re-routed, the hole can be drilled or otherwise formed in the substrate in the area 78. The hole may penetrate all the way through the substrate, allowing the control device to connect to control circuitry behind the display panel, or it may only penetrate partially through the substrate, using circuitry on the display substrate for control.

It is also possible to combine one or more of the above architectures. For example, the addressing designs of FIGS. 3 and/or 4 may be combined with the addressing designs of FIG. 6 to result in a display substrate such as that shown in FIG. 8. Co-pending U.S. patent application Ser. No. 12/253,390, assigned to the same assignee as this application, discusses a ‘cut-and-bend’ approach to making a curved surface, in which gaps or cuts in the substrate allow the substrate to be bent to close the gap or cut. This causes the substrate to become curved instead of flat. The addressing lines are routed such that they become continuous when the gap or cut is closed. Another co-pending application, U.S. patent application Ser. No. 12/017,974, also commonly owned, discusses the overall geometry of the substrate.

FIG. 8 shows a display 90 resulting from a combination of the above designs, as well as those previously discussed in the co-pending patent applications. This display has several discontinuities in its surface, including gaps or cuts 92, 94 and 96, and holes 98 and 100. The address lines would be routed in a fashion similar to that shown in FIG. 7 for the holes 98 and 100.

In addition, the address lines on either side of a cut or gap would be laid out such that they would become continuous when the gap or cut is closed. The address line portion 102 would be formed so that when the substrate is bent to close the gap 92, it would become continuous with the portion 104, forming an address line. It is also possible that the address lines could be laid out in a curved shape on the flat substrate in a fashion similar to that shown in FIG. 3, the curved shape being based upon the resulting curve formed when the gap is closed.

In this manner, a display having several discontinuities may be formed into a curved shape. This is just one possibility using the techniques described here for addressing non-rectangular displays, whether those displays have curved perimeters or discontinuities, or both.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A display system, comprising:
an array of display elements on a substrate arranged into a shape having a non-rectangular perimeter; and
address lines arranged to transmit signals to the display elements, the address lines conforming at least partially to the non-rectangular perimeter.

2. The display system of claim 1, wherein the shape has a curved perimeter.

3. The display system of claim 2, wherein the address lines have a curved shape converging at a point such that the address lines follow the curved perimeter in at least a portion of the address lines.

4. The display system of claim 3, wherein a pixel size defined by the address lines remains constant from display element to display element.

5. The display system of claim 1, wherein the shape is a polygon having more than four sides.

6. The display system of claim 5, wherein the address lines are arranged to allow addressing of the display elements from a nearest adjacent side.

7. The display system of claim 1, wherein the substrate has one or more discontinuities.

8. The display system of claim 7, wherein at least one discontinuity comprises a hole in the substrate.

9. The display system of claim 8, wherein the address lines are arranged around the hole.

10. The display system of claim 6, wherein at least one discontinuity comprises a gap between two regions of the substrate.

11. The display system of claim 10, wherein the address lines are arranged to be continuous when the substrate is bent to close the gap between the two regions.

12. A display system, comprising:
an array of display elements arranged on a substrate, the substrate having at least one holes; and
address lines arranged on the substrate to address the display elements, the address lines being routed according to the hole.

13. The display system of claim 12, wherein the hole comprises one of either a hole through the substrate or a hole partially through the substrate.

14. The display system of claim 12, wherein the hole comprises a gap in the substrate.

15. The display system of claim 14, wherein the address lines are arranged to become continuous upon bending of the substrate to close the gap.

16. The display system of claim 12, wherein the substrate has a curved perimeter.

17. The display system of claim 16, wherein the address lines have a curved shape and are arranged to follow the curved perimeter for at least some portion of their length.

18. A method of manufacturing a display system, comprising:
providing a substrate having a curved perimeter;
mapping a rectangular addressing matrix to a curved matrix, the curved matrix based on the curved perimeter;
forming address lines according to the curved matrix such that the address lines converge on at least one point;
providing an array of display elements arranged to be addressable by the address lines; and
providing control circuitry at the point to provide signals to the display elements through the address lines.

19. The method of claim 18, wherein mapping the rectangular address matrix to a curved matrix comprises identifying the point at which the address lines converge and adjusting the point to cause the address lines to follow the curved perimeter for at least a portion of a length of the address lines.

20. A method of manufacturing a display system, comprising:
providing a substrate;
arranging address lines on the substrate, such that the address lines are routed to avoid at least one region on the substrate;
forming a hole in the region, wherein the hole penetrates at least partially into the substrate; and
providing display elements on the substrate, arranged to be addressable by the address lines.

21. The method of claim 20, further comprising mounting a control device in the hole.
